(19) United States
(12) Patent Application Publication
(10) Pub. No.: US 2020/0361770 A1
(43) Pub. Date: Nov. 19, 2020

(54) COMPACT OXYGEN GENERATOR

(71) Applicant: INBAIR CO., LTD., Geumcheon-gu Seoul (KR)

(72) Inventors: Kang Soo Lee, Wonmi-dong (KR); Richard Greenwood, Bolton (GB)

(21) Appl. No.: 16/961,389

(22) PCT Filed: May 23, 2018
(86) PCT No.: PCT/KR2018/005830

§ 371 Date: Jul. 10, 2020

(30) Foreign Application Priority Data
Jan. 10, 2018 (KR) 10-2018-0003533

(51) Int. Cl. C01B 13/02; B01D 53/047

(52) U.S. Cl. CPC C01B 13/027; B01D 53/0476; B01D 2256/12; B01D 2259/40003; B01D 2259/40001

(57) ABSTRACT

Presented invention relates to a compact oxygen generator having a reduced size and reduced noise. The oxygen generator includes an upper heat sink, a lower heat sink, an air filter for filtering air introduced inside the oxygen generator, a solenoid valve for receiving the filtered air from the air filter, a zeolite module bed for separating nitrogen and oxygen from the filtered air received from the solenoid valve, and a vacuum pump supplied with the oxygen from the zeolite module bed through one discharge pipe, and supplied with the nitrogen through another discharge pipe via a vacuum chamber. The vacuum chamber ensures a specific amount of the nitrogen is supplied in a regular manner to the vacuum pump to block noise which would otherwise be generated due to the pressure change in the vacuum pump. The oxygen generator includes an internal sound insulating box for mounting the vacuum pump therein.

### CROSS-REFERENCE TO RELATED APPLICATIONS

This application is a national phase application of PCT/KR2018/005830, filed May 23, 2018, which claims priority to Korean Application No. 10-2018-0003533, filed Jan. 10, 2018; all of which are incorporated by reference herein.

### FIELD OF THE INVENTION

The present disclosure relates to oxygen generators, and more particularly, to a compact oxygen generator or oxygen generating apparatus that generates oxygen with significantly reduced noise, and is relatively smaller in size.

### BACKGROUND

Oxygen is the third most abundant element in the universe and makes up over 20% of the earth's atmosphere. In the human body, oxygen is the single most abundant element, making up 65% of body mass. We're breathing oxygen in the atmosphere nearly every second and it's a very important for human life for various reasons, such as for stress relief, increased memory and concentration, improved work performance, relaxation after exercise, and improved health of pregnant women and so on. Also, in order to breathe more oxygen, modern people's follow different forms of breathing such as yoga breathing, short-circulation breathing, double breathing, etc., which increase the diaphragm contraction and expansion. The lack of oxygen concentration in air can lead to several health issues such as decreased ability to work strenuously, coronary, pulmonary, or circulatory problems, mental failure, nausea, vomiting, fainting, unconsciousness, ashen face, blue lips and so on.

Earth's oxygen concentration is gradually decreasing due to the urbanization activities. Forests that produce most oxygen in the atmosphere are set to fire or getting destroyed due to urbanization. Several studies and research in the past has witnessed increased number of death tolls due to decrease in the concentration of oxygen in the atmosphere in the past few years.

In the past, there exists drying processes for air, refining and withdrawing processes of hydrogen, withdrawing process of CH4, withdrawing process of CO₂ from gaseous mixture, process for removal of a micro component from gaseous mixture, and its separation. Also, the concentration process of oxygen and nitrogen from air etc. Lots of researches are actively going on for the applicable expansion and improvisation of Pressure Swing Adsorption (PSA) methods adapted for producing a high purity oxygen or nitrogen by compressing or pressurizing Zeolite pellets.

Rapid Vacuum Swing Adsorption (RSVA) is one of the technologies being used in extracting specific gas from mixture of various gases. It utilizes the gap between absorptive power of a Zeolite Molecular Sieve, which can separate nitrogen, CO₂, and oxygen etc. from the mixture of various gasses.

To additionally explain the PSA method or Push method, it is a method that separates pure oxygen by application of pressure on absorbent. The RSVA method is one that separates oxygen and nitrogen efficiently by forming repeated vacuums on an adsorption tower. Particularly, in the RVSA method, an absorbent is located in an air suction part of an air compressor. When the air passing through the absorbent, a repeated vacuum is formed on the adsorption tower by a metal (Rapid) to efficiently separate oxygen and nitrogen.

Referring to FIG. 1 that shows the difference in adsorption force of Zeolite Molecular Sieve to the gases present in air. As shown in FIG. 1, when air passes through a bed filled with Zeolite Molecular Sieve, the gas molecules in the air gets absorbed in layers in the order of relative affinity.

That is, the gas components in the air are absorbed to the Zeolite bed in the order of H₂O, CO/CO₂, HC, N₂, O₂ and Ar depending on the order of affinity between the Zeolite and the gas molecules. The adsorption force is doubled in conditions of high pressure/low temperature/high concentration.

After the gas is absorbed to the end of the bed filled with the Zeolite Molecular Sieve, a purge step for purifying the absorbed gas is performed in order to regenerate the Zeolite Molecular Sieve.

The purge step can be accomplished by reducing pressure of the bed or by back-flushing concentrated gas such as oxygen. By setting up a period of gas adsorption/detachment, one can separate gas components in the air continuously without wearing down and blocking the Zeolite Molecular Sieve in the bed.

As discussed, the PSA method produces a high purity oxygen by compressing or pressurizing Zeolite pellets. The solution has its own disadvantage of producing high noise. Further, the implementation of the PSA method to extract oxygen or nitrogen requires larger setup or area involving two pressurized cylinders with molecular sieves to ensure continuous production, for separation of either oxygen or nitrogen from other gases, compressors, dryers, filter packages, air tanks and so on.

In the light of aforementioned background information, inventors of the proposed invention herein propose a compact oxygen generator having a reduced size compared to existing solutions.

### SUMMARY

It is an objective of the present invention to provide a compact oxygen generator having a reduced size as compared to the conventional apparatuses in the same space.

Another objective of the present invention is to provide a small oxygen generator having reduced noise generation.

Another objective of the present invention is to provide a small oxygen generator capable of efficiently dissipating heat generated within the generator to outside.

Another objective of the present invention is to provide a small oxygen generator capable of intuitively recognizing a period in which oxygen is discharged outside.

To this end, the proposed oxygen generator is configured in the form of a compact case. The case includes an upper heat sink, and a lower heat sink; an air filter mounted inside the case for filtering air introduced from the outside and removing moisture; a solenoid valve for receiving the air filtered in the air filter, a Zeolite module bed for separating the air supplied form the solenoid valve into nitrogen and oxygen; a vacuum pump in which the oxygen discharged from the Zeolite module bed is supplied through a first discharge pipe and the nitrogen is supplied through a second discharge pipe; and an internal sound insulating box mounted inside the case to hold the vacuum pump mounted therein.

The conventional oxygen generators have a problem that the noise generated from such oxygen generators is dissipated outside by using a fan, and they are usually large in size. On the other hand, the proposed oxygen generating apparatus is advantageous in that the heat generated inside the generator is dissipated outside by using silicone gel, thereby reducing noise. Additionally, the proposed oxygen generating apparatus have relatively reduced size.

In addition, the present invention reduces noise generated from nitrogen discharged from the Zeolite module bed. The apparatus of the present invention does this by using a vacuum chamber which controls the concentration of oxygen being discharged outside, using a filtering method tied to an air filter.

In addition, the present invention allows intuitive recognition of the discharge cycle of oxygen discharged from the oxygen generator using an LED lamp, and the discharge cycle is set in consideration of a human respiratory cycle.

These and other features and advantages of the present invention will become apparent from the detailed description below, in light of the accompanying drawings.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 illustrates the difference in adsorption force of Zeolite Molecular Sieve to various gases in air;

FIG. 2 illustrates an exploded view of a compact oxygen generator of the present invention, according to an exemplary embodiment;

FIG. 3 illustrates the compact oxygen generator of FIG. 2 with some components removed in order to show a vacuum pump mounted on an internal sound insulating box according to an exemplary embodiment;

FIG. 4 illustrates a view showing a configuration of the compact oxygen generator, according to an exemplary embodiment of the present invention.

FIG. 5 shows a timing chart, according to an exemplary embodiment of the present invention.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification. Before describing the present invention in detail, it should be observed that the present invention utilizes a combination of components which constitutes a compact oxygen generator having a reduced size, having reduced noise generation, and capable of efficiently dissipating the generated heat inside to outside. Further, the compact oxygen generator as proposed is capable of intuitively recognizing a period in which oxygen is discharged outside.

Accordingly, the components and the method steps have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

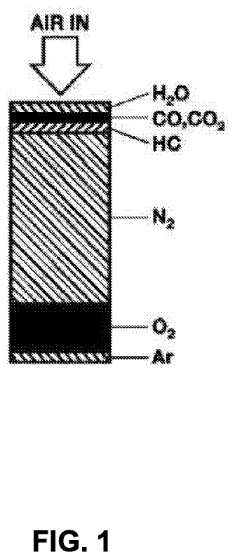

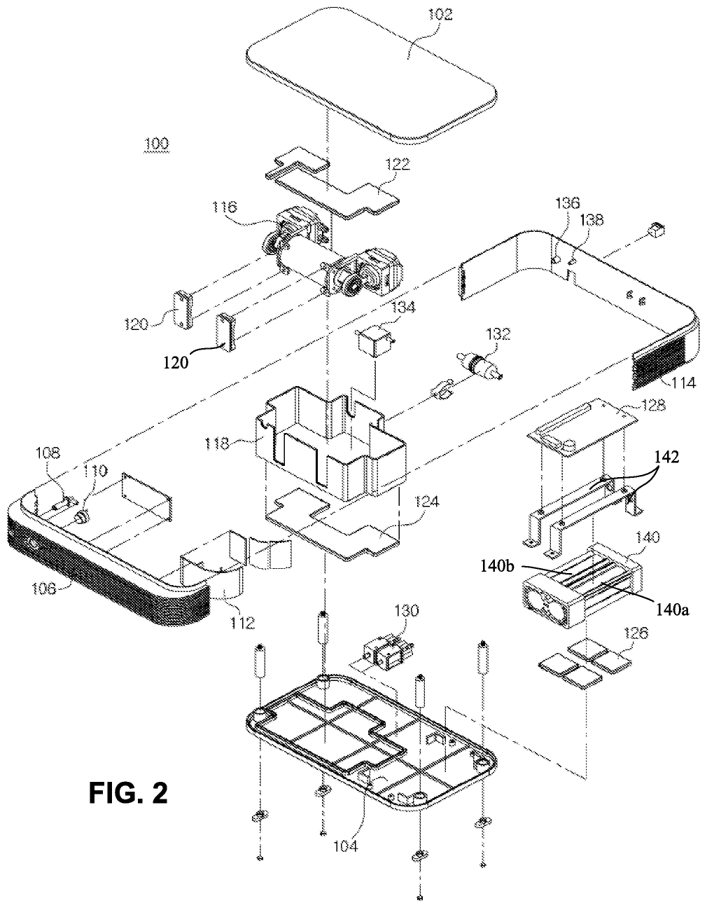

Referring now to accompanying figures, particularly FIGS. 1-5, there is provided a compact oxygen generator and method of generating oxygen thereof. Particularly, FIG. 2 shows an exploded view of the proposed compact oxygen generator of the present invention, according to an exemplary embodiment. Hereinafter, the structure of the oxygen generator will be described in detail with reference to FIG. 2. As seen in FIG. 2, the small oxygen generator 100 includes an upper heat sink or dissipating plate 102, a lower heat sink or dissipating plate 104, a front plate 106, an oxygen outlet or discharge port 108, a power switch 110, an LED diffusion plate 112, a side plate 114, a vacuum pump 116, an inner/internal sound insulating box 118, a first thermally conductive silicone gel 122, a second thermally conductive silicone gel 124, a dustproof pump bracket 120, a zeolite module bed 140, a bed fixing bracket 142, a third thermally conductive silicone gel 126, a main PCB 128, a solenoid valve 130, an air filter 132, a vacuum chamber 134, an air inlet 136, and a nitrogen outlet or discharge port 138. Although specific components are configured and operationally connected for intended functionality of the proposed oxygen generator, it should be understood that other configurations with substitute components or other additional components, or lesser components than those listed above can be included in the small oxygen generator proposed in the present invention.

The upper heat sink 102 is made preferably of aluminum material to improve the heat dissipation efficiency or exothermal efficiency. The lower heat sink 104 is also made preferably of aluminum material to improve the heat dissipation efficiency exothermal efficiency. The upper heat sink or dissipating plate 102 and the lower heat sink or dissipating plate 104 are used to efficiently dissipate the heat generated from the vacuum pump 116 and the zeolite module bed 140 to outside.

The front plate 106 is configured to fasten/assemble the upper heat sink 102 and the lower heat sink 104 together. The upper heat sink 102 and the lower heat sink 104 are configured spaced apart from each other. During assembly, one side of the front plate 106 is fastened to the upper heat sink 102, and the other side of the front plate 106 is fastened to the lower heat sink 104. The side plate 114 is also configured to fasten/assemble the upper heat sinks 102 and the lower heat sinks 104, which are laid in space apart relation. During assembly, one side of the side plate 114 is attached to the upper heat sink 102, and the other side is attached to the lower heat sink 104.

The air filter 132 filters the air sucked from the air inlet 136 (configured on the back plate 114) and the polluted air (air with contaminants) is supplied to the zeolite module bed 140 through the solenoid valve 130.

The solenoid valve 130 is configured to supply the filtered air from the air filter 132 to the zeolite module bed 140 and in particular the solenoid valve 130 supplies air sequentially to the zeolite module bed 140. The solenoid valve 130 comprises a first solenoid and a second solenoid. The zeolite module bed 140 is composed of two module beds (a first module bed 140a, and a second module bed 140b) arranged in order The detailed configuration and functions of the solenoid valve 130 and the zeolite module bed 140 will be discussed in more detail in the description to follow.

The zeolite module bed 140 is configured to receive the filtered air from the air filter 132 (through solenoid valve 130), and upon receiving the filtered air, separate nitrogen and oxygen gases which are then supplied to a vacuum pump 116. The vacuum pump 116 discharges nitrogen and oxygen supplied from the zeolite module bed 140 to the outside and performs function, which in turn reduces noise generated at this time. The bed fixing bracket 142 functions to fix the zeolite module bed 140 to the lower heat sink 104 or the main PCB 128.

The internal sound insulating box 118 functions to block noise generated during operation of the oxygen generator 100. The internal sound insulating box 118 is substantially rectangular in shape. The internal sound insulating box 118 includes a vacuum pump 116 mounted therein and functions to shut off the noise generated by the vacuum pump 116. In particular, the present invention is characterized in that a first thermally conductive silicone gel 122 is positioned or located between the vacuum pump 116 and the upper heat sink 102 to rapidly transfer heat generated from the vacuum pump 116 to the outside. The present invention is further characterized in that the second heat conductive silicone gel 124 is positioned or located between the vacuum pump 116 and the lower heat sink 104. The placement of gels 124, 126 helps in delivering the heat generated in the vacuum pump 116 to outside rapidly. The third thermally conductive silicone gel 126 is positioned or located between the lower heat sink 104 and the zeolite module bed 140 to rapidly transfer heat generated from the zeolite module bed 140 to the outside. As described above, the present invention rapidly dissipates heat generated from the zeolite module bed 140 and the vacuum pump 116 to the outside by using remarkably conductive silicone gel having excellent heat conduction efficiency.

The oxygen outlet or discharge port 108 is connected to the vacuum pump 116 and discharges oxygen to the outside. The nitrogen outlet or discharge port 138 is also connected to the vacuum pump 116 and discharges nitrogen to the outside.

The power switch 110 functions to supply power to the proposed oxygen generator 100, and the main PCB 128 embodies a circuit for driving the oxygen generator 100. The LED diffusion plate 112 displays the operating state of the oxygen generator 100. According to the present invention, the LED diffusion plate 112 indicates condition that the oxygen is discharged to the outside from the generator 100.

The dustproof pump bracket 120 functions to fix the vacuum pump 116 to the upper heat sink 102 and/or the lower heat sink 104. In other words, one side of the dustproof pump bracket 120 is assembled or fastened to the vacuum pump 116, and the other side is assembled or fastened to the upper heat sink 102 and/or the lower heat sink 104.

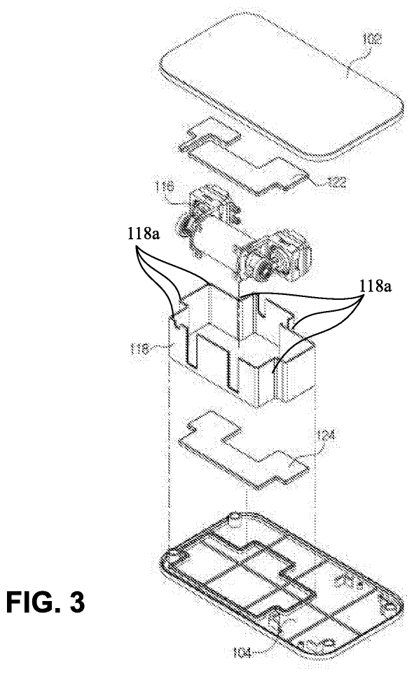

Referring to FIG. 3, the compact oxygen generator of FIG. 2 with some components removed is shown, according to an exemplary embodiment. As seen, the vacuum pump 116 is mounted within the internal sound insulating box 118. In other words, the vacuum pump 116 is assembled using the internal sound insulating box 118 according to the present invention and will be described specifically with respect to FIG. 3.

As seen, FIG. 3 just shows the upper heat sink 102, the lower heat sink 104, the first heat conductive silicone gel 122, the second heat conductive silicone gel 124, the internal sound insulating box 118, and the vacuum pump 116 described above. Particularly, the upper heat sink 102 is located at the upper end of the oxygen generator 100 and is made of a metallic material including but not limited to aluminum. The lower heat sink 104 is located at the lower end of the oxygen generator 100 and is made of a metallic material including but not limited to aluminum. The first thermally conductive silicone gel 122 is positioned between the upper heat sink 102 and the vacuum pump 116 such that when assembled one side of the silicone gel 122 remains in contact (or in close proximity) with the vacuum pump 116 and the other side of the silicone gel 122 remains in contact (or in close proximity) with the upper heat sink 102. The first thermally conductive silicone gel 122 dissipates the heat generated from the vacuum pump 116 to the outside through the closely coupled upper heat sink 102. In addition, the first thermally conductive silicone gel 122 has elasticity, so that it absorbs (or reduces) the vibration (or noise) generated in the vacuum pump 116. Likewise, the second thermally conductive silicone gel 124 is positioned between the lower heat sink 104 and the vacuum pump 116 such that when assembled, one side of the silicone gel 124 remains in contact (or in close proximity) with the vacuum pump 116 and the other side of the silicone gel 124 remains in contact (or in close proximity) with the lower heat sink 104. The second thermally conductive silicone gel 124 dissipates the heat generated in the vacuum pump 116 to the outside through the adhered lower heat sink 104. Also, since the second thermally conductive silicone gel 124 has elasticity, the second thermally conductive silicone gel 124 also absorbs the vibration (or noise) generated in the vacuum pump 116.

The internal sound insulating box 118 embodies the vacuum pump 116 mounted therein as described above. As seen in FIG. 3, the sides of the vacuum pump 116 is sealed by walls of the internal sound insulating box 118, the top or upper portion is sealed by the first thermally conductive silicone gel 122, and the lower portion or bottom is sealed by the second thermally conductive silicone gel 124. As seen, the vacuum pump 116 as enclosed inside the internal sound insulating box 118 is fully sealed by the internal sound insulating box 118, the first thermally conductive silicone gel 122, and the second thermally conductive silicone gel 124.

Additionally, the internal sound insulating box 118 is strategically designed and includes a plurality of bending portions or bend lines 118a in order to block noise generated therein. In other words, the internal sound insulating box 118 that have multiple bending portions 118a can efficiently absorb the noise/vibration generated within it from the vacuum pump 116. According to one example, the internal sound insulating box 118 may have at least 10 bend lines.

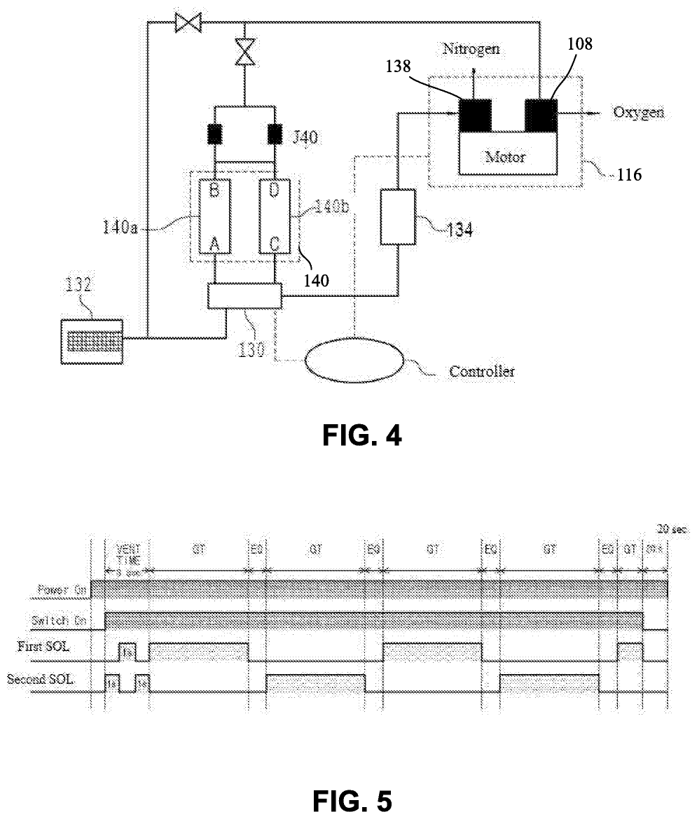

Referring to FIG. 4, a configuration or internal architecture of the compact oxygen generator 100 is shown, according to an exemplary embodiment of the present invention. As seen in FIG. 4, the compact oxygen generator 100 includes an air filter 132, a solenoid valve 130, a zeolite module bed 140, a vacuum chamber 134, a vacuum pump 116, a nitrogen outlet 138, a controller, and an oxygen outlet 108. It should be understood that other configurations than as identified above can be included in the oxygen generator proposed in the present invention.

The air filter 132 filters the air introduced from the outside. Generally, the air introduced from the outside contains pollutants/contaminants and moisture, so the air filter 132 filters pollutants/contaminants and removes moisture.

The solenoid valve 130 supplies the filtered air from the filter 132 to the first module bed 140a or the second module bed 140b of the zeolite module bed 140. The air filtered by the air filter 132 is further supplied to the vacuum pump 116 by the solenoid valve 130.

The zeolite module bed 140 separates the supplied air into oxygen and nitrogen. Oxygen separated from the zeolite module bed 140 is supplied to the vacuum pump 116 and nitrogen separated from the zeolite module bed 140 is supplied to a vacuum chamber 134 through a second discharge pipe. The vacuum chamber 134 offers nitrogen which is provided from the zeolite module bed 140 to the vacuum pump 116, and in particular a certain amount of it is provided to the vacuum pump 116. Since the vacuum chamber 134 provides the specific amount of nitrogen to the vacuum pump 116 it can block noise which would be generated from the pressure change. To this, in the case the vacuum chamber 134 isn't formed, nitrogen which is discharged from the zeolite module bed 140 is discharged irregularly depending on the movement of the solenoid valve 130, not discharging a certain amount. This irregularly discharged nitrogen can cause generation of noise. In order to solve this problem, the present invention proposes placement of the vacuum chamber 134 at the back of zeolite module bed 140.

Particularly, the present invention forms the vacuum chamber 134 on the second discharge pipe through which nitrogen is discharged from the zeolite module bed 140. In contrast, there is no any vacuum chamber formed on a first discharge pipe through which oxygen is discharged. The reason why no vacuum chamber is configured or formed on the first discharge pipe through which oxygen is discharged will be described in the description to follow.

The vacuum pump 116 discharges the nitrogen supplied from the vacuum chamber 134 to the outside through the nitrogen outlet 138. The vacuum pump 116 mixes the air supplied from the air filter 132 and the oxygen supplied from the zeolite module bed 140, and discharges the mixture through the oxygen outlet 108. The present invention discharges not only the oxygen supplied from the zeolite module bed 140 through the oxygen outlet 108 but also the air supplied from the air filter 132 to the outside.

That is, when it is necessary to adjust the concentration of oxygen discharged through the oxygen outlet 108, the concentration of oxygen is adjusted using the air supplied from the air filter 132. If it is necessary to increase the oxygen concentration, only the oxygen supplied from the zeolite module bed 140 is discharged to the outside. If it is necessary to lower or decrease the oxygen concentration, the oxygen supplied from the zeolite module bed 140 and the air filter 132 are provided. The supplied from zeolite module bed 140 and the air filter 132 mixed and discharged to the outside.

As described above, in the present invention, not only the oxygen supplied from the zeolite module bed 140 is discharged to the outside, but the air supplied from the air filter 132 is appropriately mixed and discharged to the outside to adjust the concentration of oxygen to be discharged. In addition, a vacuum chamber is not formed on the first discharge pipe through which oxygen is discharged from the zeolite module bed 140. This is because a certain amount of air (oxygen containing air) is supplied to the vacuum pump 116 through the air introduced by the air filter 132. In other words, the zeolite module bed 140 supplies nitrogen to the vacuum pump 116 in an irregular manner (irregular amounts). On the other hand, the vacuum chamber 134 isn't formed on the first discharge pipe which discharges oxygen, as oxygen is supplied in regular manner (regular amounts) to the vacuum pump 116 compared to nitrogen. This is the reason no vacuum chamber is formed on the first discharge pipe through which oxygen is discharged. Further, as seen, the controller mounted of the main PCB 128 controls the electrical communication between the components described above.

Referring to FIG. 5, a timing chart, according to an exemplary embodiment of the present invention is shown. According to FIG. 5, power ON, switch ON, a first solenoid (SOL) ON, and a second solenoid (SOL) ON are included. The power ON indicates a state in which power is supplied to the compact oxygen generator 100, the switch ON indicates a state of supplying power to the first solenoid or the second solenoid, and the first solenoid ON indicates a state in which power is supplied to the first solenoid and the second solenoid ON indicates a state where power is supplied to the second solenoid.

The timing chart of FIG. 5 also shows a time (GT time) for generating oxygen and a time for desorbing the adsorbed nitrogen (EQ time). The GT time is 3.5 sec, and the EQ time is 0.1 sec. It should be understood by those skilled in the art that GT time and EQ time can be adjusted if necessary.

When the power is turned on, a switch is used to supply power to the first solenoid or the second solenoid. In this case, power is supplied to only of the first solenoid or the second solenoid at the same time.

At the initial time of supplying power to the solenoid, power is supplied to the second solenoid for 1 second, and then power is supplied to the first solenoid for 1 second. Then, the power is supplied to the second solenoid for 1 second. Then, power is supplied for 3.5 seconds to generate oxygen for normal operation of the first solenoid. The power supply of the first solenoid is stopped to remove the nitrogen adsorbed to the first solenoid, and the power is supplied to the second solenoid after 0.1 second.

As described above, the present invention sequentially supplies power to the first solenoid and the second solenoid to repeat oxygen generation and nitrogen desorption.

In particular, the present invention generates oxygen for 3.5 seconds, and the reason for stopping oxygen generation for 0.1 second is to match the human respiratory cycle. That is, in general, the respiration rate of the human per minute is 12 to 20, and the present invention adjusts the driving period of the small oxygen generator so as to conform to the human respiration cycle. Besides that, the present invention uses an LED lamp (not seen) configured in the front plate 106 to recognize or identify the cycle of oxygen discharge which is emitted from the compact oxygen generator. It suggests a way to make the flashing period of the LED lamp consistent with an oxygen discharging cycle. The flashing period of the LED lamp is preferably half of the operating cycle of the first solenoid or the second solenoid.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

We claim:

1. A compact oxygen generator (100), comprising:
an upper heat sink (102);
a lower heat sink (104);
an air filter (132) configured for filtering air introduced from outside and for removing moisture content from the introduced air;
a solenoid valve (130) adapted for receiving the filtered air from the air filter (132);
a zeolite module bed (140) adapted for receiving the filtered air from the solenoid valve (130), and separating nitrogen and oxygen from the received filtered air;
a vacuum pump (116), the vacuum pump (116) is supplied with the oxygen from the zeolite module bed (140) through a first discharge pipe, and supplied with the nitrogen through a second discharge pipe via a vacuum chamber (134) formed therein, wherein the vacuum chamber (134) ensures a specific amount of the nitrogen is supplied in a regular manner to the vacuum pump (116) to block noise which would otherwise be generated due to the pressure change in the vacuum pump (116); and
an internal sound insulating box (118) configured inside the compact oxygen generator (100) and having the vacuum pump (116) mounted therein.

2. The oxygen generator (100) of claim 1, wherein the upper heat sink (102) and the lower heat sink (104) are configured to dissipate the heat generated from the vacuum pump (116) and the zeolite module bed (140) to outside.

3. The oxygen generator (100) of claim 1 further comprising:
a first thermally conductive silicone gel (122) positioned between the vacuum pump (116) and the upper heat sink (102) to rapidly transfer heat generated from the vacuum pump (116) to the outside;
a second thermally conductive silicone gel (124) positioned between the vacuum pump (116) and the lower heat sink (104) to rapidly transfer heat generated from the vacuum pump (116) to the outside; and
a third thermally conductive silicone gel (126) is positioned between the lower heat sink (104) and the zeolite module bed (140) to rapidly transfer heat generated from the zeolite module bed (140) to the outside.

4. The oxygen generator (100) of claim 1, wherein the upper heat sink (102) and the lower heat sink (104) are made of aluminium.

5. The oxygen generator (100) of claim 1, wherein the internal sound insulating box (118) is substantially rectangular in shape and comprises a plurality of bending portions or bend lines (118a) in order to shut off noise generated by the vacuum pump (116).

6. The oxygen generator (100) of claim 1 further comprising a dustproof pump bracket (120) configured to fix the vacuum pump (116) to the upper heat sink (102) and/or the lower heat sink (104).

7. The oxygen generator (100) of claim 1, wherein the solenoid valve (130) includes a first solenoid and a second solenoid, the solenoid valve (130) sequentially drives the first solenoid and the second solenoid, and wherein the solenoid valve (130) drives the second solenoid after a predetermined time lapse after driving the first solenoid.

8. The oxygen generator (100) of claim 1 further comprising an LED lamp configured in the front plate (106) to identify cycles of oxygen discharge from the compact oxygen generator. and/or flashing period of the LED lamp.

9. The oxygen generator (100) of claim 8, wherein the flashing period of the LED lamp corresponds to half of a driving period of the first solenoid or the second solenoid.

10. The oxygen generator (100) of claim 1 further comprising a bed fixing bracket (142) adapted for attaching the zeolite module bed (140) to the lower heat sink (104) or to a main PCB (128).

11. The oxygen generator (100) of claim 1 further comprising:
an air inlet (136) configured on the back plate (114) for introducing air from outside that's then filtered by the air filter (132);
a nitrogen outlet (138) connected to the vacuum pump (116) for discharging nitrogen outside from the oxygen generator (100); and
an oxygen outlet (108) connected to the vacuum pump (116) for discharging oxygen outside from the oxygen generator (100).
